(19) United States
(12) Patent Application Publication
(10) Pub. No.: US 2006/0131248 A1
(43) Pub. Date: Jun. 22, 2006

(54) Process for removing dissolved oxygen from an aqueous system

(76) Inventors: Kostan B. Charkhutian, Westwood, NJ (US); Bruce L. Libutti, Teaneck, NJ (US)

Correspondence Address: David L. Hedden;ASHLAND INC., P.O. Box 2219, Columbus, OH, 43216, US

(21) Appl. No.: 11/015,570

(22) Filed: Dec. 17, 2004

(51) Int. Cl. C02F 1/20

(52) U.S. Cl. 210/750

(57) ABSTRACT

This invention relates to a process for removing dissolved oxygen from an aqueous system, which comprises adding a composition comprising (a) piperazine, water soluble derivatives of thereof, and mixtures thereof, and (b) a hydroxybenzene, water soluble derivatives thereof, and mixtures thereof.

### TECHNICAL FIELD

This invention relates to a process for removing dissolved oxygen from an aqueous system, which comprises adding a composition comprising (a) piperazine, water soluble derivatives of thereof, and mixtures thereof, and (b) a hydroxybenzene, water soluble derivatives thereof, and mixtures thereof.

### BACKGROUND OF THE INVENTION

The presence of dissolved oxygen in steam generating systems causes the cathode of corrosion cells to depolarize and prolong the corrosion process. Additionally dissolved oxygen will promote ammonia corrosion of copper condenser tubes. Therefore it is essential that dissolved oxygen concentration be kept at the lowest level throughout steam generating system to prevent such corrosion-related problems.

The presence of dissolved oxygen in industrial/institutional water systems, such as steam generating systems, causes the cathode of corrosion cells to depolarize and prolong the corrosion process. Additionally dissolved oxygen promotes ammonia corrosion of copper condenser tubes and chelant corrosion of metal tubes and pump parts.

The mitigation of corrosion in steam generating systems is vital to the continued efficient operation of the systems. Oxygen pitting can rapidly lead to failures while formation of metal oxides results in deposition, causing reduced heat transfer rates and under-deposit corrosion. The limited deposit tolerances in boilers require that the corrosion inhibition program perform optimally. Therefore, it is essential that dissolved oxygen concentrations be kept at the lowest level possible throughout the steam generating system.

In most steam generating systems, the reduction or elimination of oxygen is achieved by mechanical means, followed by the addition of chemicals, which are known in the industry as oxygen scavengers. For example methyl ethyl ketoxime (MEKO) is well known as an oxygen scavenger and metal passivator in boilers. See U.S. Pat. No. 4,487,745. This patent indicates that the amount of oxime used in treating boiler water is from 0.0001 ppm to 500 ppm, although commercial utility plant experience indicates that the typical dosage of MEKO used to control feedwater oxygen is from 30-80 ppb. MEKO controls corrosion in the feedwater circuit by scavenging oxygen and by establishing a corrosion-resistant oxide film on waterside metallic surfaces.

Another known oxygen scavenger is a secondary hydroxylamine, diethyl hydroxylamine (DEHA). See U.S. Pat. Nos. 4,067,690 and 4,350,606.

All citations referred to under this description of the “Related Art” and in the “Detailed Description of the Invention” are expressly incorporated by reference.

### BRIEF SUMMARY OF THE INVENTION

This invention relates to a process for removing dissolved oxygen from an aqueous system, which comprises adding a composition comprising (a) piperazine and/or water soluble derivatives of thereof, and (b) a hydroxybenzene and/or water soluble derivatives thereof.

Although the composition can be used in any steam generating system, the composition is particularly useful where temperatures are insufficient to activate other oxygen scavengers. Examples include certain boiler systems such as shipboard auxiliary boilers and boilers in lay-up.

The process further involves maintaining the dosage of composition in the aqueous system for a time sufficient to further reduce the level of oxygen in the aqueous system. The process can be carried out effectively at ambient temperatures. The corrosion potential for the boiler tube surfaces is also reduced when this process is used. The use of this process also results in cost savings because there is less need for frequent cleanings of the operating equipment, e.g. boilers, if the process is used. Further savings result by using this process because heat generated by the boiler is more efficient.

### DETAILED DESCRIPTION OF THE INVENTION

The detailed description and examples will illustrate specific embodiments of the invention will enable one skilled in the art to practice the invention, including the best mode.

The first component comprises piperazine and/or its water-soluble derivatives. Piperazine and its derivatives are represented by the following structural formula: 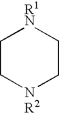
wherein R₁ and R₂ are the same or different and are preferably selected from hydrogen and lower alkyl chains terminating in polar groups to impart water solubility. Examples of derivatives of piperazine that can be used include 1-(2-aminoethyl) piperazine, and 1-(2-hydroxyethyl) piperazine. Most preferably used is 1-(2-aminoethyl) piperazine.

The second component comprises a water-soluble hydroxybenzene or derivatives thereof represented by the following structural formula: 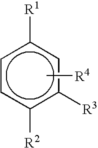
wherein R₁ and R₂ are OH groups, R₃ is H or OH, and R₄ is H or a lower alkyl group.

Examples of hydroxybenzenes include hydroquinone, tolylhydroquinone and pyrogallol. The ratio of the first component to the second component is from about 1:1 to about 100:1. Preferably from about 5:1 to about 100:1 and most preferably from about 10:1 to about 100:1

Although not required, the composition can be added to a feedpoint that will expose the composition to a temperature of about 30° C. to about 320° C.

The typical dosage of the composition is used in an aqueous system with thermal and/or mechanical deaeration for a feedwater (for a boiler which is in operation) oxygen scavenging is in the range of 5 ppb to 1000 ppb, preferably from about 10 ppb to 500 ppb, most preferably from about 50 ppb to 100 ppb. The typical dosage of the composition used in an aqueous system without thermal and/or mechanical deaeration for a feedwater (for a boiler which is in operation) is in the range of 5 to 500 ppm, preferably from about 15 ppm to 200 ppm, most preferably from about 15 ppm to 150 ppm. For boilers in lay-up, the typical dosage of the composition is used in the range of 5 to 500 ppm, preferably from about 15 ppm to 200 ppm, most preferably from about 5 ppm to 150 ppm.

Although it is not critical to inject the composition into a particular injection point, typical injection points where the composition can be added to an aqueous stream of a steam generator include the pre-boiler system of the steam generator, the boiler steam drum of the steam generator, the highest-temperature feedwater heater extraction steam of the lower pressure steam turbine, the main steam header prior to the turbine, the turbine crossover piping, and satellite feeds to stream condensate lines.

The components of the composition can be added separately or pre-mixed before adding them to the aqueous system to be treated. Preferably, the piperazine and/or, water soluble derivative of thereof and the hydroxybenzene and/or water-soluble derivative thereof are pre-mixed before adding them to the aqueous system.

Abbreviations:

PIP piperazine:

HEPIP 1-(2-hydroxyethyl) piperazine.

AEPIP 1(2-aminoethyl) piperazine.

HQ hydroquinone.

### EXAMPLES

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. The Control did not contain piperazine, a derivative of piperazine or a hydroxybenzene.

### Examples

### Control and 1-3

### Use of Piperazine and Piperazine Derivatives as Oxygen Scavengers

Dissolved oxygen and pH were monitored on sample compositions at ambient temperature in order to evaluate the effectiveness of the compositions in scavenging dissolved oxygen. The monitoring system consisted of Hach DO175 dissolved oxygen meter equipped with a probe, a Cole-Parmer pH meter equipped with a pH and ATC probes, a four-neck round bottom flask, and a stirrer. The evaluations were done by adding known amounts of piperazine or derivatives of piperazine followed by the addition of the hydroxybenzene or derivative thereof, or by adding known amounts of blends that contained piperazine derivatives and hydroxybenzene to oxygen-saturated deionized water. The pH of the test solutions was maintained at 10.00-10.20 using dilute sodium hydroxide solution. Reagent grade piperazine and/or piperazine derivatives were used in the evaluation.

Table I shows dissolved oxygen data over time for various levels of piperazine.

TABLE I

| | | | % Oxygen Remaining | | | |
|---|---|---|---|---|---|---|
| | PIP | HQ | (Time in minutes) | | | |
| Example | (ppm) | (ppm) | 0 | 10 | 20 | 30 |
| Control | 0 | 0 | 100 | 100 | 100 | 100 |
| A | 10.2 | 0 | 100 | 100 | 100 | 100 |
| B | 0 | 1.5 | 100 | 52 | 45 | 45 |
| 1 | 10.2 | 1.5 | 100 | 20 | 20 | 21 |
| C | 22.8 | 0 | 100 | 100 | 100 | 100 |
| D | 0 | 1.5 | 100 | 52 | 45 | 45 |
| 2 | 22.8 | 1.5 | 100 | 10 | 10 | 11 |

Table II shows dissolved oxygen data over time for various levels of 1-(2-hydroxyethyl) piperazine.

TABLE II

| | | | % Oxygen Remaining | | | |
|---|---|---|---|---|---|---|
| | HEPIP | HQ | (Time in minutes) | | | |
| Example | (ppm) | (ppm) | 0 | 10 | 20 | 30 |
| Control | 0 | 0 | 100 | 100 | 100 | 100 |
| A | 15.8 | 0 | 100 | 100 | 100 | 100 |
| B | 0 | 1.5 | 100 | 52 | 45 | 45 |
| 1 | 15.8 | 1.5 | 100 | 28 | 28 | 28 |
| C | 31.5 | 0 | 100 | 100 | 100 | 100 |
| D | 0 | 1.5 | 100 | 52 | 45 | 45 |
| 2 | 31.5 | 1.5 | 100 | 19 | 19 | 19 |

Table III shows dissolved oxygen data over time for various levels of 1(2-aminoethyl) piperazine.

TABLE III

| | | | % Oxygen Remaining | | | |
|---|---|---|---|---|---|---|
| | AEPIP | HQ | (Time in minutes) | | | |
| Example | (ppm) | (ppm) | 0 | 10 | 20 | 30 |
| Control | 0 | 0 | 100 | 100 | 100 | 100 |
| A | 14.0 | 0 | 100 | 100 | 100 | 100 |
| B | 0 | 1.5 | 100 | 52 | 45 | 45 |
| 1 | 14.0 | 1.5 | 100 | 22 | 21 | 21 |
| C | 37.5 | 0 | 100 | 100 | 100 | 100 |
| D | 0 | 1.5 | 100 | 52 | 45 | 45 |
| 2 | 37.5 | 1.5 | 100 | 12 | 10 | 10 |

The data in Tables I through III show that piperazine and piperazine derivatives alone do not scavenge oxygen at ambient temperature. Additionally, the data show that the combination of piperazine, or piperazine derivatives, and hydroquinone remove more oxygen than piperazine, piperazine derivatives, or hydroquinone alone. The data indicate that there is a synergy when piperazine or piperazine derivatives and hydroquinone are used together, since the effectiveness of these combinations in removing oxygen was unexpected in view of their effectiveness when used individually.

1. A process for removing dissolved oxygen from an aqueous system, which comprises adding a composition comprising:
(a) piperazine and/or a water-soluble piperazine derivative thereof as represented by the following structural formula, 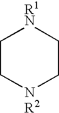
wherein R₁ and R₂ are the same or different, and are selected from hydrogen, lower alkyl chains, and lower alkyl groups terminating in polar groups that impart water solubility to said lower alkyl group, and
(b) a water-soluble hydroxybenzene and/or water-soluble derivative thereof,
such that the ratio of (a) to (b) is from about 1:1 to about 100:1, to the aqueous system in amount effective to remove dissolved oxygen from the aqueous system.

2. The process of claim 1 wherein the composition comprises 1-(2-aminoethyl) piperazine and hydroquinone.

3. The process of claim 1 wherein the composition is injected at ambient temperature.

4. The process of claim 1 wherein the composition is injected into an aqueous stream of a steam generating system with an operating boiler.

5. The process of claim 4 wherein the injection point for the composition is selected from the group consisting of the pre-boiler system of the steam generator, the boiler steam drum of the steam generator, the highest-temperature feedwater heater extraction steam of the lower pressure steam turbine, the main steam header prior to the turbine, the turbine crossover piping, and satellite feeds to stream condensate lines.

6. The process of claim 5 wherein there is mechanical deaeration.

7. The process of claim 1, 2, 3, 4, 5, or 6 wherein the ratio of component (a) to component (b) is from about 10:1 to about 100:1

8. The process of claim 7 wherein dosage of the composition is from of 5 ppb to 1000 ppb.

9. The process of claim 4 wherein there is no provision for mechanical deaeration.

10. The process of claim 9 wherein dosage of the composition is from 5 ppm to 500 ppm.

11. The process of claim 1 wherein the composition is injected into the water contained in a boiler in lay-up.

12. The process of claim 11 wherein the dosage of the composition is from 5 ppm to 500 ppm.
